(19) United States
(12) Patent Application Publication
(10) Pub. No.: US 2026/0181277 A1
(43) Pub. Date: Jun. 25, 2026

(54) IMAGE SENSOR FOR SECURING IMAGE HAVING HIGH DYNAMIC ILLUMINATION RANGE

(71) Applicant: SAMSUNG ELECTRONICS CO., LTD., Suwon-si (KR)

(72) Inventors: Ho Yong NA, Suwon-si (KR); Kyung-Min KIM, Suwon-si (KR); Young Tae JANG, Suwon-si (KR)

(73) Assignee: SAMSUNG ELECTRONICS CO., LTD., Suwon-si (KR)

(21) Appl. No.: 19/543,499

(22) Filed: Feb. 18, 2026

Related U.S. Application Data
(62) Division of application No. 18/495,020, filed on Oct. 26, 2023.

(30) Foreign Application Priority Data
Mar. 22, 2023 (KR) 10-2023-0037303
Apr. 20, 2023 (KR) 10-2023-0051818

(51) Int. Cl. H04N 25/59; H04N 25/771; H04N 25/772; H04N 25/778; H04N 25/78

(52) U.S. Cl. CPC H04N 25/59; H04N 25/771; H04N 25/772; H04N 25/778; H04N 25/78

(57) ABSTRACT

An image sensor includes pixels. Each pixel includes a first photodiode, a second photodiode, an overflow transistor having one end connected to the second photodiode, a storage capacitor, a capacitor connection transistor having a first end connected to the storage capacitor and a second end connected to the second photodiode, a first transistor connected to the first photodiode, a second transistor connected to the second photodiode, a first floating node connected to the first photodiode through the first transistor, a second floating node connected to the second photodiode through the second transistor, a conversion gain transistor between the first floating node and the second floating node, a driving transistor connected to the first photodiode, and a selection transistor connected to the driving transistor. The first photodiode has a larger light receiving area than the second photodiode.

### CROSS-REFERENCE TO RELATED APPLICATIONS

This application is a Divisional of U.S. patent application Ser. No. 18/495,020, filed on Oct. 26, 2023, which claims priority under 35 U.S.C. §119 to Korean Patent Application No. 10-2023-0037303 filed on Mar. 22, 2023 in the Korean Intellectual Property Office (KIPO), and Korean Patent Application No. 10-2023-0051818 filed on Apr. 20, 2023 in the KIPO, the disclosures of which are herein incorporated by reference in their entireties.

### FIELD

The present disclosure generally relates to an image sensing technology, and more particularly relates to an image sensor and an operating method thereof.

### DISCUSSION

Image sensors are devices capable of converting optical information into electrical signals. An image sensing device may include complementary metal-oxide semiconductor (CMOS)-type image sensors, and each of the image sensors may include an array of pixels arranged two-dimensionally. Each of the pixels may include at least one photodiode, where the photodiode converts an amount of light incident thereupon into an electrical signal.

Image sensors may be used not only in mobile devices such as smartphones, but also in surveillance cameras and vehicles, for example. Image sensors may be designed to secure a high dynamic range to represent both brightest areas and darkest areas in a single image at substantially the same time. For example, CMOS-type image sensors may obtain images with high dynamic ranges to render both high-illumination environments (e.g., in the presence of high-intensity light such as in direct sunlight) and low-illumination environments (e.g., in the presence of low-intensity light such as in tunnels).

### SUMMARY

Embodiments of the present disclosure may provide an image sensor capable of securing an image having a high dynamic range.

Embodiments of the present disclosure may also provide an operating method of an image sensor capable of securing an image having a high dynamic range.

However, embodiments of the present disclosure are not restricted to those set forth herein. The above and other embodiments of the present disclosure will become more apparent to those of ordinary skill in the art to which the present disclosure pertains by referencing the detailed description of the present disclosure as presented by way of example below.

According to an embodiment of the present disclosure, there is provided an image sensor comprising a pixel including a first photodiode, a second photodiode, a storage capacitor connected to the second photodiode, an overflow transistor connected to the second photodiode, and a read circuit, a driver configured to provide control signals to the pixel, an analog-to-digital converter (ADC) block configured to generate sub-digital signals by comparing an output signal of the pixel with a ramp signal, a controller configured to control operations of the driver and the ADC block, wherein the first photodiode has a larger light-receiving area or a greater sensitivity than the second photodiode.

According to an embodiment of the present disclosure, there is provided an image sensor comprising a first pixel arranged in a first row, a second pixel connected to substantially the same column line as the first pixel and arranged in a second row, a pixel connection transistor connected to the first and second pixels, a driver providing control signals, which are to be transmitted to the first and second pixels, an analog-to-digital converter (ADC) block generating sub-digital signals by comparing an output signal of each of the first and second pixels with a ramp signal, a controller controlling operations of the driver and the ADC block, wherein each of the first and second pixels includes a first photodiode, a first floating node, a first transfer transistor, which is connected between the first photodiode and the first floating node, a conversion gain transistor, which is connected to the first floating node, a reset transistor, which is connected between the conversion gain transistor and a first voltage, a second photodiode, a second transfer transistor, which is connected between the second photodiode and the second floating node, a storage capacitor, which stores some of electric charge generated by the second photodiode, an overflow transistor, which removes some of the electric charge generated by the second photodiode, a third floating node, which is connected in common to the conversion gain transistor and the reset transistor, a connection transistor, which is connected to the second and third floating nodes, and a read circuit, which outputs an output signal to the column line in response to a voltage of the first floating node, the pixel connection transistor is connected between the third floating nodes of the first and second pixels, wherein the first photodiode has a larger light-receiving area or a greater sensitivity than the second photodiode, the first pixel outputs first, second, and third sub-output signals, which are obtained by converting electric charge generated by the first photodiode during an exposure period, with first, second, and third conversion gains, respectively, first, second, and third reset signals corresponding to the first, second, and third sub-output signals, respectively, fourth and fifth sub-output signals, which are obtained by converting some of electric charge generated by the second photodiode during the exposure period, with fourth and fifth conversion gains, respectively, and fourth and fifth reset signals corresponding to the fourth and fifth sub-output signals, respectively, and as the pixel connection transistor is turned on, the first pixel generates the third and fifth sub-output signals with the third floating nodes of the first and second pixels electrically connected.

According to an embodiment of the present disclosure, there is provided an operating method of an image sensor including a first photodiode, a first floating node, a second photodiode, a second floating node, a storage capacitor, which is connected to the second photodiode, an overflow transistor, which is connected to the second photodiode, and a read circuit, the first photodiode having a larger light-receiving area or a greater sensitivity than the second photodiode, the operating method comprises removing first portions of electric charge generated by the second photodiode during an exposure period, via the overflow transistor, storing second portions of the electric charge in the storage capacitor, and transmitting third portions of the electric charge to the second floating node, outputting first and second sub-output signals, which are obtained by converting electric charge generated by the first photodiode, with first and second conversion gains, respectively, outputting first and second reset signals corresponding to the first and second sub-output signals, respectively, via the read circuit, and sequentially outputting third and fourth sub-output signals, which are obtained by converting the electric charge generated by the first photodiode, with third and fourth conversion gains, respectively, and fourth and third reset signals corresponding to the fourth and third sub-output signals, respectively, via the read circuit.

It shall be understood that embodiments of the present disclosure are not limited to those described above, and that these and other embodiments of the present disclosure will be apparent from the following descriptions.

### BRIEF DESCRIPTION OF THE DRAWINGS

The above and other embodiments of the present disclosure will become more apparent by describing in detail illustrative embodiments thereof with reference to the attached drawings, in which:

FIGS. 1A through 1C are block diagrams of image sensors according to some embodiments of the present disclosure;

FIG. 2 is a circuit diagram of an illustrative pixel applicable to the image sensors of FIGS. 1A through 1C;

FIG. 3 is a plan view diagram illustrating part of a pixel array having the pixel of FIG. 2 applied thereto;

FIG. 4 is a layout view diagram of the pixel of FIG. 2;

FIG. 5 is a timing diagram illustrating a first-mode operation of the pixel of FIG. 2;

FIG. 6 is a timing diagram of a second-mode operation of the pixel of FIG. 2;

FIG. 7 is a circuit diagram of an illustrative pixel applicable to the image sensors of FIGS. 1A through 1C;

FIG. 8 is a timing diagram illustrating a second-mode operation of the pixel of FIG. 7;

FIG. 9 is a circuit diagram of an illustrative pixel applicable to the image sensors of FIGS. 1A through 1C;

FIG. 10 is a timing diagram illustrating a first-mode operation of the pixel of FIG. 9;

FIG. 11 is a circuit diagram illustrating how pixels are connected; and

FIG. 12 is a timing diagram illustrating second-mode operations of the pixels of FIG. 11.

### DETAILED DESCRIPTION

Embodiments of the present disclosure may have various modifications and may be embodied in various different forms, and shall not be construed as being limited to those described by way of example herein. Rather, the illustrated embodiments are provided as examples so that the present disclosure will be thorough and complete, and will fully convey the inventive concept of the present disclosure to those skilled in the art. It shall be understood that the inventive concept includes all modifications, equivalents, and replacements within the idea and technical scope of the present disclosure.

Moreover, it shall be understood that, although the terms “first,” “second,” “third,” etc., may be used herein to describe various elements, components, regions, layers and/or sections; that such elements, components, regions, layers and/or sections shall not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It shall be understood that when an element, layer, region, or component is referred to as being “formed on,” “on,” “connected to,” or “coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. Moreover, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. Moreover, other expressions describing relationships between components such as “between,” “immediately between” or “adjacent to” and “directly adjacent to” may be construed similarly. In addition, it shall also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a,” “an,”, and “the” are intended to include the plural forms as well, unless the context clearly indicates otherwise. It shall be further understood that the terms “comprises” and/or “comprising,” when used in this specification, specify the presence of the stated features, integers, steps, operations, elements, components and/or groups, but do not preclude the presence or addition of one or more other features, integers, steps, operations, elements, components, and/or groups thereof.

Embodiments of the present disclosure are hereinafter described with reference to the accompanying drawings.

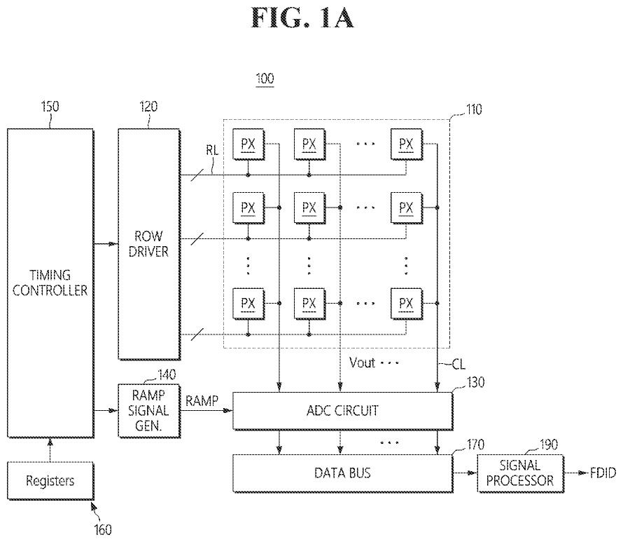

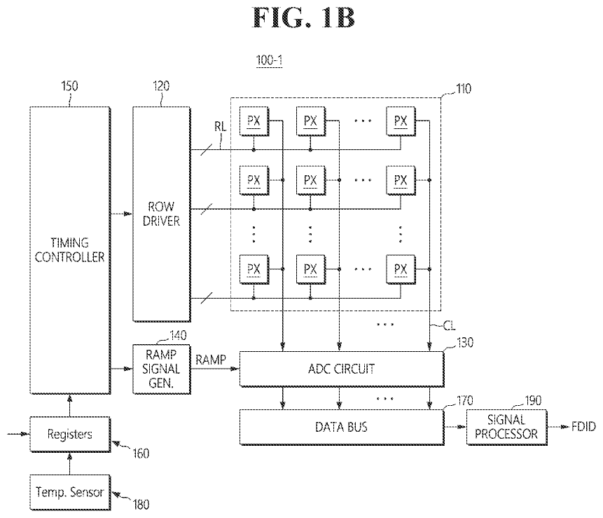

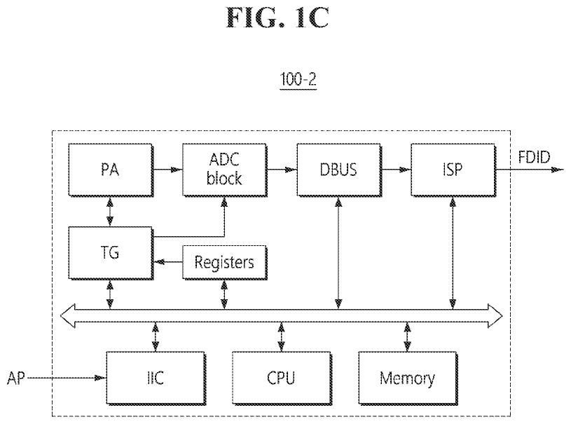

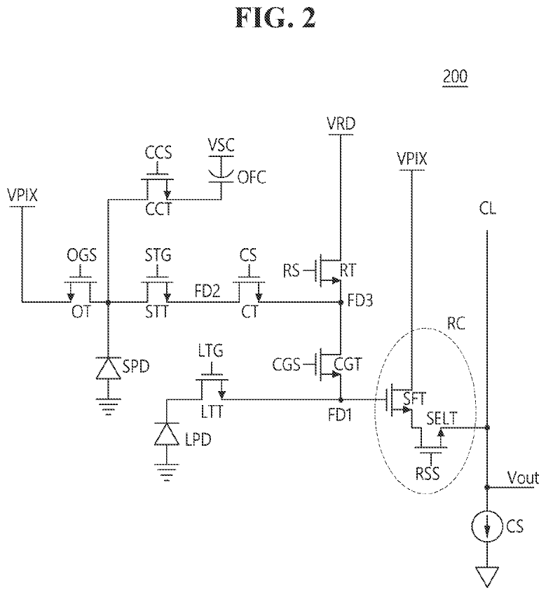

FIG. 1A illustrates an image sensor according to an embodiment of the present disclosure. FIG. 2 shows an illustrative pixel circuit applicable to the image sensors of FIG. 1A through 1C.

Referring to FIG. 1A, an image sensor 100 may include a pixel array 110, a row driver 120, an analog-to-digital converter (ADC) circuit 130, a ramp signal generator (“RAMP SIGNAL GEN.”) 140, a timing controller 150, mode setting registers 160, a data bus 170, and a signal processor 190.

Referring to FIGS. 1A and 2, the pixel array 110 may include an array of pixels PX, which are arranged in rows and columns that are connected to row lines RL and column lines CL, respectively. Each of the pixels PX may include a first or large photodiode LPD and a second or small photodiode SPD. Each of the pixels PX may also include transistors for converting electric charge generated by the first and second photodiodes LPD and SPD into electrical signals. A light-receiving area of the first photodiode LPD may be larger than a light-receiving area of the second photodiode SPD. In other words, the light-receiving area of the second photodiode SPD may be smaller than the light-receiving area of the first photodiode LPD. Thus, the first photodiode LPD may generate a larger amount of electric charge than the second photodiode SPD when exposed to substantially the same amount of light for substantially the same amount of time. Accordingly, the sensitivity of the first photodiode LPD may be greater than the sensitivity of the second photodiode SPD. Moreover, even at relatively low illumination levels, the first photodiode LPD can generate a sufficient amount of electric charge to be converted into electrical signals.

The second photodiode SPD may be connected to a storage capacitor OFC, which stores first portions of the generated electric charge, and to an overflow transistor OT, which is capable of removing second portions of the generated electric charge. Because the ratio between electric charge removed by the overflow transistor OT and electric charge stored in the storage capacitor OFC can be controlled, an image signal can be secured even at high illumination by controlling the sensitivity of the second photodiode SPD.

The transistors may include first and second transfer transistors LTT and STT, which are connected to the first and second photodiodes LPD and SPD, respectively, a reset transistor RT, a conversion gain transistor CGT, and a read circuit RC formed by a driving transistor SFT and a selection transistor SELT.

The electric charge generated by the first photodiode LPD may be converted with first or second conversion gain, depending on whether the conversion gain transistor CGT is turned on or off, thereby generating an electrical signal. In addition, each of the pixels PX may output electrical signals by converting the electric charge generated by the second photodiode SPD with third conversion gain and converting the electric charge stored in the storage capacitor OFC with fourth conversion gain.

The row driver 120 may drive the pixel array 110 in units corresponding to the rows. The row driver 120 may decode a signal (e.g., an address signal) received from the timing controller 150 and may select at least one of the rows in response to the decoded signal. The row driver 120 may transmit control signals to selected rows for generating an output signal Vout from the pixel array 110 via the column lines CL. In an embodiment, the row driver 120 may function as a voltage driver. The control signals may include the first and second transfer control signals LTG and STG, an overflow gate control signal OGS, a reset control signal RS, a connection control signal CS, a conversion gain control signal CGS, and a capacitor connection control signal CCS. The row driver 120 may provide the control signals to the pixel array 110 at voltages corresponding to a reset period, an exposure period, and a read-out period, respectively.

The mode setting register 160 is a register with which an application processor (AP) may set an operating mode of the image sensor 100 via an interface connected to the image sensor 100. The operating mode of the image sensor 100 may be set by the AP on the basis of frames, which are units of image data output from the image sensor 100 to the AP. Signals to be output during the read-out period may be controlled depending on the set operating mode of the image sensor 100.

Operating modes of the image sensor 100 may include at least first and second operating modes. In the first operating mode, first and second sub-output signals may be generated by converting some electric charges generated by the first photodiode LPD into first and second conversion gains, respectively; a third sub-output signal may be generated by converting an electric charge generated by the second photodiode SPD into a third conversion gain, and a fourth sub-output signal may be generated by converting an electric charge stored in the storage capacitor OFC into a fourth conversion gain.

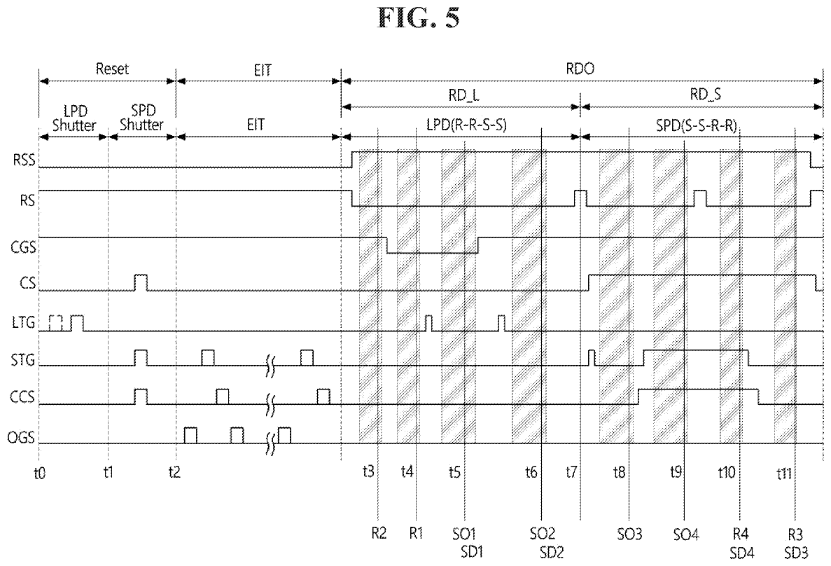

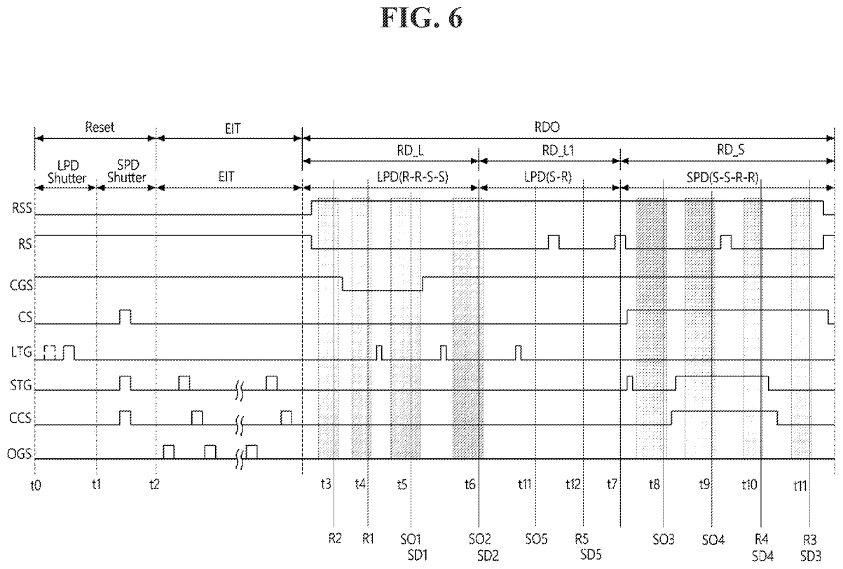

In the second operating mode, fifth sub-output signals may be generated between the first and second sub-output signals and between the third and fourth sub-output signals by converting the electric charge generated by the first photodiode LPD into the second conversion gain. The waveforms of the control signals applied to each of the pixels PX in the first and second operating modes may be described in greater detail further below with reference to FIGS. 5 and 6.

The timing controller 150 may generally control the row driver 120, the ramp signal generator 140, the ADC block 130, and the signal processor 190 in accordance with the operating mode set by the mode setting register 160.

The ramp signal generator 140 may generate a ramp signal RAMP having a voltage that increases or decreases with a predetermined slope, and may provide the ramp signal RAMP to the ADC block 130.

The ADC block 130 may receive the output signal Vout from at least one row of pixels PX, selected by the row driver 120, via the column lines CL. In the first operating mode, the output signal Vout may include first and second sub-output signals corresponding to electric charges generated by the first photodiode LPD, and third and fourth sub-output signals corresponding to electric charges generated by the second photodiode SPD, and may also include reset signals for the first, second, third, and fourth sub-output signals. In the second operating mode, the output signal Vout may further include a fifth sub-output signal between the first and second sub-output signals or between the third and fourth sub-output signals, and may also include a reset signal for the fifth sub-output signal.

The ADC circuit 130 may include multiple ADCs, which correspond to the respective column lines CL. The ADCs may compare sub-output signals received via the respective column lines CL and reset signals for the received sub-output signals having the ramp signal RAMP, and may generate sub-digital signals by digitalizing comparison signals, obtained as a result of the comparison.

The ADCs may generate the sub-digital signals using correlated double sampling (CDS). CDS is a technique of sampling the reset level and the signal level of a floating node, which is the gate of a driving transistor of a read circuit of a pixel, and outputting the difference between the sampled reset and signal levels. CDS may be classified into a first-type CDS that reads out the reset level of the floating node of a pixel first and then reads out the signal level of the floating node of the pixel, or a second-type CDS that reads out the signal level of the floating node of a pixel first and then reads out the reset level of the floating node of the pixel.

In the first operating mode, each of the ADCs of the ADC block 130 may generate a first sub-digital signal by performing first-type CDS using the first sub-output signal and a first reset signal for the first sub-output signal, generate a second sub-digital signal by performing first-or second-type CDS using the second sub-output signal and a second reset signal for the second sub-output signal, generate a third sub-digital signal by performing second-type CDS using the third sub-output signal and a third reset signal for the third sub-output signal, and generate a fourth sub-digital signal by performing second-type CDS using the fourth sub-output signal and a fourth reset signal for the fourth sub-output signal.

In the second operating mode, each of the ADCs of the ADC block 130 may further generate a fifth sub-digital signal by performing second-type CDS using the fifth sub-output signal and a fifth reset signal for the fifth sub-output signal, after the generation of the second sub-digital signal and before the generation of the third sub-digital signal.

The data bus 170 may sequentially receive the first, second, third, and fourth sub-digital signals from the ADC block 130 in the first operating mode, or may sequentially receive the first, second, third, fourth, and fifth sub-digital signals from the ADC block 130 in the second operating mode. The data bus 170 may temporarily store and align the received sub-digital signals and may output the aligned sub-digital signals to the signal processor 190. The data bus 170 may include a memory and a memory controller. Sub-digital signals stored in the memory may be output to the signal processor under the control of the memory controller.

The signal processor 190 may generate a final digital image signal FDID by merging the first, second, third, and fourth sub-digital signals or the first, second, third, fourth, and fifth sub-digital signals, received via the data bus 170. The signal processor 190 may generate a digital image signal by selecting appropriate signals that are yet to saturate from among the first, second, third, fourth, and fifth sub-digital signals or using at least two of the first, second, third, fourth, and fifth sub-digital signals. The signal processor 190 may perform signal processing such as noise reduction, gain adjustment, waveform shaping, interpolation, white balance processing, gamma processing, edge emphasis, and binning on the generated digital image signal, thereby obtaining the final digital image signal FDID. In an embodiment, some signal processing functions described above as performed by the signal processor 190 may alternatively be implemented in an external processor outside the image sensor 100.

FIG. 1B illustrates an image sensor according to an embodiment of the present disclosure.

Referring to FIG. 1B, an image sensor 100-1 is substantially the same as the image sensor 100 of FIG. 1A, except that it further includes a temperature sensor (“Temp. Sensor”) 180. Duplicate description may be omitted. The image sensor 100-1 may set a mode setting register 160 via an external interface and may change the setting value of the mode setting register 160 in accordance with temperature information from the temperature sensor 180. That is, the operating mode of the image sensor 100-1 may vary depending on the operating temperature of the image sensor 100-1.

FIG. 1C illustrates an image sensor according to an embodiment of the present disclosure.

Referring to FIG. 1C, an image sensor 100-2 is substantially the same as the image sensor 100 of FIG. 1A or the image sensor 100-1 of FIG. 1B, except that it further includes a central processing unit (CPU) and a memory. Duplicate description may be omitted. The image sensor 100-2 includes the CPU, and the CPU controls the other elements of the image sensor 100-2, including a timing controller, by executing driving firmware stored in the memory.

An AP may write an address and a change value corresponding to one of multiple firmware (FW) registers that is allocated for the operating mode of the image sensor 100-2, to the memory via an external interface such as a Connection Control Interface (CCI) interface or an Inter-Integrated Circuit (I2C) interface. Before each frame starts, the CPU may read the change values of the FW registers from the memory and may change the setting value of a mode setting register. That is, the image sensor 100-2 may change the operating mode of the image sensor 100-2 via the FW registers. In an embodiment, the image sensor 100-2 may further include the temperature sensor 180 of FIG. 1B.

Referring to FIG. 2, a pixel 200 may include a first photodiode LPD, a second photodiode SPD, a read circuit RC, a storage capacitor OFC, and transistors.

The first and second photodiodes LPD and SPD are photodiodes having different sensitivities due to differences in size, type, or configuration. For example, the first and second photodiodes LPD and SPD may be photodiodes of different sizes, without limitation thereto. The first photodiode LPD may have a larger light-receiving area than the second photodiode SPD and may thus be able to generate a larger amount of electric charge than the second photodiode SPD under substantially the same light-receiving conditions. That is, the first photodiode LPD may have a higher sensitivity than the second photodiode SPD and may generate a valid pixel output signal at a lower illumination than the second photodiode SPD. The second photodiode SPD may generate a valid pixel output signal at a higher illumination than the first photodiode LPD.

The first photodiode LPD may be connected to a first floating node FD1, which is a first floating area, via a first transfer transistor LTT. The first transfer transistor LTT may transmit electric charge generated by the first photodiode LPD during an exposure period, to the first floating node FD1 in response to a first transfer control signal LTG.

An overflow transistor OT may connect the second photodiode SPD to a pixel voltage VPIX, and may remove first portions of electric charge generated by the second photodiode SPD during the exposure period, in response to an overflow gate control signal OGS.

The second photodiode SPD may be connected to the storage capacitor OFC through a capacitor connection transistor CCT. The capacitor connection transistor CCT may store and accumulate second portions of the electric charge generated by the second photodiode SPD during the exposure period, in response to a capacitor connection signal CCS. Another node of the storage capacitor OFC may be connected to a storage voltage VSC.

The second photodiode SPD may be connected not only to a second transfer transistor STT and the overflow transistor OT, but also to the capacitor connection transistor CCT. The second photodiode SPD may be connected to a second floating node FD2, which is a second floating area, via the second transfer transistor STT, and the second transfer transistor STT may transmit third portions of the electric charge generated by the second photodiode SPD during the exposure period, to the second floating node FD2 in response to a second transfer control signal STG.

The sensitivity of the second photodiode SPD may be lowered at high illumination by removing some of the electric charge generated by the second photodiode SPD via the overflow transistor OT. That is, an image signal can be generated even at high illumination by controlling the sensitivity of the second photodiode SPD in accordance with the ratio between the amount of electric charge discarded via the overflow transistor OT and the amount of electric charge stored in the storage capacitor OFC, and as a result, a high dynamic range can be secured.

The read circuit RC includes a driving transistor SFT and a selection transistor SELT. The driving transistor SFT may function as a source follower amplifier responding to a voltage corresponding to the electric charge transmitted to the first floating node FD1, based on the pixel voltage Vpix and a bias current generated by a current source CS, which is connected to a column line CL. The selection transistor SELT may transmit the output of the driving transistor SFT to the column line CL as an output signal Vout.

The transistors of the pixel 200 may further include a connection transistor CT, a reset transistor RT, and a conversion gain transistor CGT. The connection transistor CT may be positioned between the second floating node FD2 and a third floating node FD3, which is a third floating area, and may connect the second and third floating nodes FD2 and FD3 such as in response to a connection control signal CS.

The reset transistor RT may be positioned between a reset voltage VRD and the third floating node FD3 and may reset the electric charge stored in at least one of the first floating node FD1, the third floating node FD3, and the storage capacitor OFC, in response to a reset control signal RS. In some embodiments, the reset voltage VRD may be substantially the same as the pixel voltage Vpix. In an embodiment, the storage voltage VSC may be substantially the same as the reset voltage VRD or the pixel voltage Vpix.

The conversion gain transistor CGT may be positioned between the first and third floating nodes FD1 and FD3 and may connect the first and third floating nodes FD1 and FD3 in response to a conversion gain control signal CGS.

Conversion gain refers to the rate at which the voltage at a floating node is changed by electric charge transmitted to the floating node. For a given amount of electric charge transmitted to a floating node, conversion gain may vary depending on the capacitance of the floating node. As the capacitance of a floating node increases, conversion gain may decrease, and as the capacitance of a floating node decreases, conversion gain may increase. The electric charge generated by the first photodiode LPD may be converted with different conversion gains, such as first and second conversion gains, depending on whether the conversion gain transistor CGT is turned on or off. When the conversion gain transistor CGT is turned off, the electric charge generated by the first photodiode LPD may be converted into an output signal Vout with first conversion gain by the capacitance of the first floating node FD1, and when the conversion gain transistor CGT is turned on, the electric charge generated by the first photodiode LPD may be converted into an output signal Vout with second conversion gain by the sum of the capacitances of the first and third floating nodes FD1 and FD3. The first conversion gain may be greater than the second conversion gain.

The electric charge generated by the second photodiode SPD may be converted into an output signal Vout with third conversion gain by the sum of the capacitances of the first, second, and third floating nodes FD1, FD2, and FD3, with the conversion gain transistor CGT and the connection transistor CT both turned on. The electric charge stored in the storage capacitor OFC, among the electric charge generated by the second photodiode SPD, may be converted into an output signal Vout with fourth conversion gain by the sum of the capacitances of the first, second, and third floating nodes FD1, FD2, and FD3 and the capacitance of the storage capacitor OFC, with the conversion gain transistor CGT, the connection transistor CT, and the capacitor connection transistor CCT are all turned on.

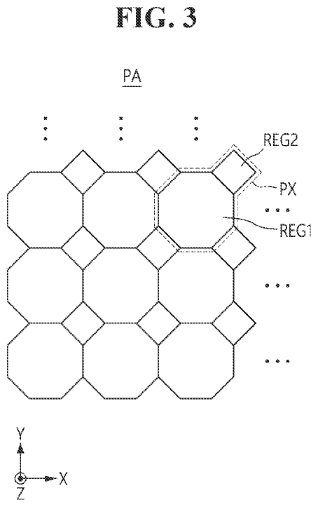

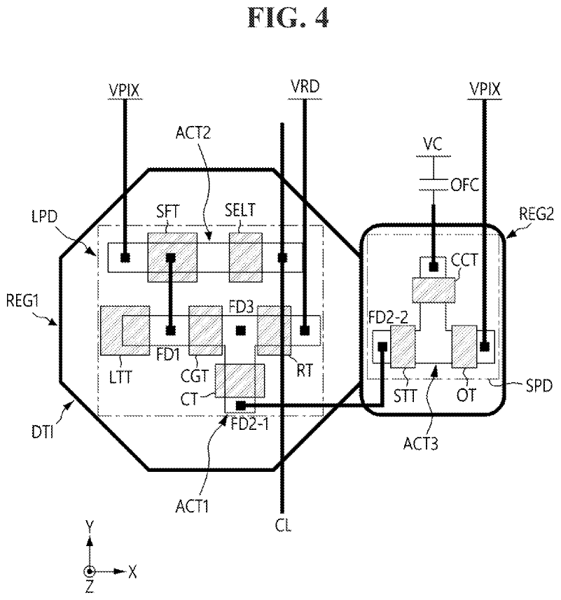

FIG. 3 illustrates part of the pixel array of FIG. 1, which includes pixels according to the embodiment of FIG. 2. FIG. 4 illustrates how the elements of the pixel of FIG. 2 are arranged in first and second pixel regions.

Referring to FIG. 3, the pixel array 110 includes a plurality of pixels PX. The pixels PX may be regularly arranged in first and second directions X and Y. Each of the pixels PX may include first and second regions REG1 and REG2, which are adjacent to each other. The first region REG1 may be at least twice larger than the second region REG2. The first region REG1 may have an octagonal shape, and the second region REG2 may have a quadrangular shape. However, the present disclosure is not limited to this. The shapes of the first and second regions REG1 and REG2 may vary, as long as the size of the first region REG1 is greater than the size of the second region REG2 or the sensitivity of the first region REG1 is greater than the sensitivity of the second region REG2.

Referring to FIG. 4, the first and second regions REG1 and REG2 may be positioned adjacent to each other. The first region REG1 may include a first photodiode LPD, a first transfer transistor LTT, a conversion gain transistor CGT, a reset transistor RT, a connection transistor CT, and a read circuit, which includes a driving transistor SFT and a selection transistor SELT, and may also include first and third floating nodes FD1 and FD3 and part FD2-1 of a second floating node FD2, without limitation thereto.

The first photodiode LPD may be formed below, and overlap with, first and second active regions ACT1 and ACT2 where transistors are formed, in a vertical direction Z. One node (e.g., the drain) of the selection transistor SELT of the read circuit, which is disposed in the first region REG1, may be connected to a column line CL. One node such as the drain of the driving transistor SFT of the read circuit may be connected to a pixel voltage VPIX, and one node such as the drain of the reset transistor RT may be connected to a reset voltage VRD.

The second region REG2 may include a second photodiode SPD, a second transfer transistor STT, an overflow transistor OT, and a capacitor connection transistor CCT and may also include part FD2-2 of the second floating node FD2. The second photodiode SPD may be formed below, and overlap with, a third active region ACT3 in the vertical direction Z.

One node such as the drain of the overflow transistor OT, which is disposed in the second region REG2, is connected to the pixel voltage VPIX. One node of the capacitor connection transistor CCT is connected to a storage capacitor OFC. The storage capacitor OFC may be disposed at an upper part, in the vertical direction Z, of the corresponding pixel PX, as a metal insulator metal (MIM) capacitor. The part FD2-2 of the second floating node FD2 may be connected to the part FD2-1 of the second floating node FD2 via a metal line.

The first and second regions REG1 and REG2 may be arranged to adjoin on at least one side thereof, and may be separated by a deep trench isolation (DTI) to electrically isolate the first and second photodiodes LPD and SPD and prevent optical crosstalk.

In an alternate embodiment, as the resolution of the image sensor 100 increases, the size of pixels PX decreases, and thus, all the transistors except for the second photodiode SPD and the second transfer transistor ST may be disposed in the first region REG1. In an alternate embodiment, only the second photodiode SPD, the second transfer transistor STT, and the overflow transistor OT may be disposed in the second region REG2, and the capacitor connection transistor CCT may be disposed in the first region REG1.

The image sensor 100 including the pixel array may include a first semiconductor substrate including the pixel array 110 and a second semiconductor substrate including the rest of the image sensor 100. The first and second semiconductor substrates may be stacked and may transmit signals to each other via through-silicon vias (TSVs) penetrating the first semiconductor substrate or via another connection means.

Alternatively, in an embodiment, the image sensor 100 may include three semiconductor substrates. The pixel array 110 may include two semiconductor chips, such as upper and lower semiconductor chips. In this case, the first photodiode LPD, the second photodiode SPD, and the first and second transfer transistors LTT and STT of each of the pixels PX may be formed in the upper semiconductor chip, and the other transistors and the storage capacitor OFC of each of the pixels PX may be formed in the lower semiconductor chip.

FIG. 5 shows timing for a first-mode operation of the pixel of FIG. 2. The operation timing of the pixel 200 in the first operating mode may hereinafter be described with reference to FIGS. 2 and 5.

FIG. 5 illustrates the waveforms of control signals applied to the gates of the transistors of the pixel 200, including a selection control signal RSS, the reset control signal RS, the conversion gain control signal CGS, the connection control signal CS, the first transfer control signal LTG, the second transfer control signal STG, the capacitor connection control signal CCS, and the overflow gate control signal OGS. These control signals may be generated as pulses by the row driver 120 of FIG. 1A or 1B and may be provided to the pixel array 110 of FIG. 1A or 1B, under the control of the timing controller 150 of FIG. 1A or 1B. The pulses may toggle between a high level and a low level. The high level turns on the transistors of the pixel 200 and the low level turns off the transistors of the pixel 200. Some of the transistors of the pixel 200 may be implemented as P-type metal-oxide semiconductor (PMOS) transistors, in which case, the waveforms of the pulses may be the opposite to that illustrated in FIG. 5.

A period from a start time t0 to an end time t11 may be one horizontal (1H) period, which is a period from when the photodiodes of the pixel 200 are reset to when the output signal Vout is output. The length of the 1H period multiplied by the number of rows of pixels of the pixel array 110 may be a substantially minimum amount of time that it takes to generate an image data signal for a single frame.

The period of the first-mode operation of the pixel 200 may include a reset period Reset, an exposure period EIT, and a read-out period RDO, without limitation thereto.

Referring to FIGS. 2 and 5, the reset period Reset may include a first-photodiode-shutter period “LPD Shutter”, such as from t0 to t1, during which the first and third floating nodes FD1 and FD3 and the first photodiode LPD are reset together by toggling the first transfer control signal LTG while maintaining the selection control signal RSS at the low level and maintaining the reset control signal RS and the conversion gain control signal CGS at the high level so that the first and third floating nodes FD1 and FD3 are connected, and a second-photodiode-shutter period “SPD Shutter”, such as from t1 to t2, during which the first, second, and third floating nodes FD1, FD2, and FD3, the storage capacitor OFC, and the second photodiode SPD are reset together by toggling the second transfer control signal STG, the connection control signal CS, and the capacitor connection control signal CCS. The first-photodiode-shutter period “LPD Shutter” and the second-photodiode-shutter period “SPD Shutter” may be performed at substantially the same time.

During the exposure period EIT, the overflow gate control signal OGS, the second transfer control signal STG, and the capacitor connection control signal CCS may be toggled multiple times, while maintaining the reset control signal RS and the conversion gain control signal CGS at the high level and the first transfer control signal LTG at the low level. The first photodiode LPD may generate and accumulate electric charge by receiving light during the exposure period EIT. The second photodiode SPD may also generate and accumulate electric charge by receiving light during the exposure period EIT, but first portions of the electric charge may be removed by the overflow transistor OT, second portions of the electric charge may be stored in the storage capacitor OFC, and third portions of the electric charge may be transmitted to the second floating node FD2 via the second transfer transistor STT. The amount of electric charge to be removed by the overflow transistor OT, such as the size of the first portions of the electric charge generated by the second photodiode SPD, may be controlled by controlling the number of times the overflow gate control signal OGS is toggled during the exposure period EIT and the duration that the overflow gate control signal OGS is maintained at the high level whenever toggled. The amount of electric charge to be stored in the storage capacitor OFC, such as the size of the second portions of the electric charge generated by the second photodiode SPD, may be controlled by controlling the number of times the capacitor connection control signal CCS is toggled during the exposure period EIT and the duration that the capacitor connection control signal CCS is maintained at the high level whenever toggled. The amount of electric charge to be stored in the second floating node FD2, such as the size of the third portions of the electric charge generated by the second photodiode SPD, may be controlled by controlling the number of times the second transfer control signal STG is toggled during the exposure period EIT and the duration that the second transfer control signal STG is maintained at the high level whenever toggled.

The exposure period EIT may be, for example, 11 ms or longer, to minimize flicker that may be caused by a light-emitting diode (LED) light source, which is for use in a traffic light. The second transfer control signal STG needs to be toggled at least once after the last toggling of the overflow gate control signal OGS, to safely sense an LED light source turned on after the toggling of the overflow gate control signal OGS.

The read-out period RDO may include a first-photodiode-read period RD_L and a second-photodiode-read period RD_S, which follows the first-photodiode-read period RD_L, when the selection transistor SELT is turned on. During the read-out period RDO, the selection control signal RSS is maintained at the high level.

During the first-photodiode-read period RD_L, the pixel 200 may sequentially output a second reset signal R2 with second conversion gain, a first reset signal R1 with first conversion gain, a first sub-output signal SO1 with the first conversion gain, and a second sub-output signal SO2 with the second conversion gain via the column line CL. When the conversion gain control signal CGS transitions to the high level, the conversion gain transistor CGT is turned on, and the electric charge transmitted by the first photodiode LPD may be converted into a voltage with the second conversion gain, using the sum of the capacitances of the first and third floating nodes FD1 and FD3. When the conversion gain control signal CGS transitions to the low level, the conversion gain transistor CGT is turned off, and the electric charge transmitted by the first photodiode LPD may be converted into a voltage with the first conversion gain, using only the capacitance of the first floating node FD1. For example, the capacitance used in the second conversion gain may be greater than the capacitance used in the first conversion gain, and the second conversion gain may be less than the first conversion gain.

At a time t3, the conversion gain transistor CGT is turned on so that the second reset signal R2 with the second conversion gain is output to the column line CL. At a time t4, the conversion gain transistor CGT is turned off so that the first reset signal R1 with the first conversion gain is output to the column line CL. Thereafter, as the first transfer control signal LTG is toggled with the conversion gain transistor CGT turned off, the electric charge accumulated in the first photodiode LPD are transmitted to the first floating node FD1. At a time t5, the first sub-output signal SO1 is output with the first conversion gain. Thereafter, the conversion gain transistor CGT is turned back on, the electric charge transmitted to the first floating node FD1 are shared with the third floating node FD3, and the electric charge accumulated in the first photodiode LPD are transmitted to the first and third floating nodes FD1 and FD3 by toggling the first transfer control signal LTG again. At a time t6, the second sub-output signal SO2 is output with the second conversion gain.

The ADC block 130 of FIG. 1A may generate a first sub-digital signal SD1 by performing a first first-type CDS process using the first reset signal R1 and the first sub-output signal SO1, and may generate a second sub-digital signal SD2 by performing a second first-type CDS process using the second reset signal R2 and the second sub-output signal SO2. Here, each first-type CDS process is a type of CDS process that receives the reset level of the pixel 200 first and then receives the signal level of the pixel 200.

FIG. 5 shows that during the first photodiode-read period RD_L, the second reset signal R2, the first reset signal R1, the first sub-output signal SO1, and the second sub-output signal SO2 are sequentially output from the pixel 200, but alternatively, the first reset signal R1, the first sub-output signal SO1, the second sub-output signal SO2, and the second reset signal R2 may be sequentially output by controlling the conversion gain control signal CGS differently. In greater detail, the first reset signal R1 may be output at the time t3 by switching the conversion gain control signal CGS to the low level, the first sub-output signal SO1 may be output at the time t4 by toggling the first transfer control signal LTG, the second sub-output signal SO2 may be output at the time t5 by switching the conversion gain control signal CGS to the high level, and the second reset signal R2 may be output at the time t6 by toggling the reset control signal RS.

At a time t7, the electric charge transmitted from the first photodiode LPD to the first and third floating nodes FD1 and FD3 are removed by toggling the reset control signal RS with the conversion gain transistor CCT turned on.

During the second-photodiode-read period RD_S, the pixel 200 the pixel 200 sequentially outputs a third sub-output signal SO3 with third conversion gain, a fourth sub-output signal SO4 with fourth conversion gain, a fourth reset signal R4 with the fourth conversion gain, and a third reset signal R3 with the third conversion gain via the column line CL. The third conversion gain may convert the electric charge shared between the first, second, and third floating nodes FD1, FD2, and FD3 into a voltage using the sum of the capacitances of the first, second, and third floating nodes FD1, FD2, and FD3 with the conversion gain transistor CGT and the connection transistor CT both turned on. The fourth conversion gain may convert the electric charge shared between the storage capacitor OFC and the first, second, and third floating nodes FD1, FD2, and FD3, using the sum of the capacitance of the storage capacitor OFC and the capacitances of the first, second, and third floating nodes FD1, FD2, and FD3 with the conversion gain transistor CGT, the connection transistor CT, and the capacitor connection transistor CCT are all turned on. The fourth conversion gain may be less than the third conversion gain.

Thereafter, the connection transistor CT is turned on by switching the connection control signal CS to the high level, and the electric charge transmitted to the second floating node FD2 during the exposure period EIT is shared with the first and third floating nodes FD1 and FD3 by toggling the second transfer control signal STG. Electric charge that has been accumulated in the second photodiode SPD since the last toggling of the second transfer control signal STG during the exposure period EIT are transmitted to the first, second, and third floating nodes FD1, FD2, and FD3 by toggling the second transfer control signal STG. At a time t8, the third sub-output signal SO3 with the third conversion gain is output to the column line CL.

After the output of the third sub-output signal SO3 at the time t8, the electric charge stored in the storage capacitor OFC is transmitted to, and shared between, the first, second, and third floating nodes FD1, FD2, and FD3 by switching the capacitor connection control signal CCS to the high level to turn on the capacitor connection transistor CCT. At a time t9, the fourth sub-output signal SO4 with the fourth conversion gain is output to the column line CL.

After the output of the fourth sub-output signal SO4 at the time t9, electric charge is substantially removed from the first, second, and third floating nodes FD1, FD2, and FD3, the storage capacitor OFC, and the second photodiode SPD with the conversion gain transistor CGT, the connection transistor CT, the second transfer control signal STG, and the capacitor connection transistor CCT are all turned on. At a time t10, the fourth reset signal R4 with the fourth conversion gain is output to the column line CL.

Thereafter, the second transfer control signal STG and the capacitor connection control signal CCS are both switched to the low level, and at a time t11, the third reset signal R3 with the third conversion gain is output.

The ADC block 130 of FIG. 1A may generate a fourth sub-digital signal SD4 by performing a first second-type CDS process using the fourth sub-output signal SO4 and the fourth reset signal R4, and may generate a third sub-digital signal SD3 by performing a second second-type CDS process using the third sub-output signal SO3 and the third reset signal R3. Here, the second-type CDS process receives the signal level of the pixel 200 first to reset the pixel 200 and then receives the reset level of the pixel 200 to perform CDS. The second-type CDS process, unlike first-type CDS process, does not reset the pixel 200 first and uses, as the third sub-output signal SO3, the electric charge generated by the second photodiode SPD during the exposure period EIT and then transmitted to the second floating node FD2 via the second transfer transistor STT. Thus, the effect of increasing the amount of electric charge captured by the second photodiode SPD can be achieved.

During the read-out period RDO, the pixel 200 may sequentially output the second reset signal R2, the first reset signal R1, the first sub-output signal SO1, the second sub-output signal SO2, the third sub-output signal SO3, the fourth sub-output signal SO4, the fourth reset signal R4, and the third reset signal R3 to the column line CL, and the ADC block 130 may generate third and fourth sub-digital signals SD3 and SD4 by performing a second-type CDS process using the third and fourth sub-output signals SO3 and SO4, which are output signals associated with the second photodiode SPD.

After the read-out period RDO, the first, second, third, and fourth sub-digital signals SD1, SD2, SD3, and SD4 may be transmitted to the signal processor 190 of FIG. 1A, and the signal processor 190 may generate a final digital image signal FDIS by merging the first, second, third, and fourth sub-digital signals SD1, SD2, SD3, and SD4.

FIG. 6 shows timing for a second-mode operation of the pixel of FIG. 2. The embodiment of FIG. 6 is substantially the same as the embodiment of FIG. 5 except that the period of the second-mode operation of the pixel 200 further includes an additional read period RD_L1, during which electric charge is output from the first photodiode LPD again, between a first-photodiode-read period RD_L and a second-photodiode-read period RD_S. Duplicate description may be omitted.

The additional read period RD_L1 ranges from a time t6, which is the end of the first-photodiode-read period RD_L during which the second reset signal R2, the first reset signal, the first sub-output signal SO1, and the second sub-output signal SO2 are output, to a time t7, which is the beginning of the second-photodiode-read period RD_S during which electric charge generated by the first photodiode LPD and then transmitted from the first photodiode LPD to the first and third floating nodes FD1 and FD3 are reset. Thereafter, electric charge generated by the first photodiode LPD after the toggling of the first transfer control signal LTG after a time t5 are additionally transmitted to the first and third floating nodes FD1 and FD3 by toggling the first transfer control signal LTG with the conversion gain transistor CGT turned on. A fifth sub-output signal SO5 is output at a time t11 by converting the electric charge transmitted to the first and third floating nodes FD1 and FD3, with the second conversion gain. Thereafter, the first and third floating nodes FD1 and FD3 are reset by toggling the reset control signal RS, and a fifth reset signal R5 is output with the second conversion gain at a time t12. The ADC block 130 of FIG. 1A may generate a fifth sub-digital signal SD5 by performing a second-type CDS process using the fifth sub-output signal SO5 and the fifth reset signal R5.

The fifth sub-output signal SO5, which is output during the additional read period RD_L1, can render a brighter image than the second sub-output signal SO2, using a relatively large amount of electric charge generated in the first photodiode LPD.

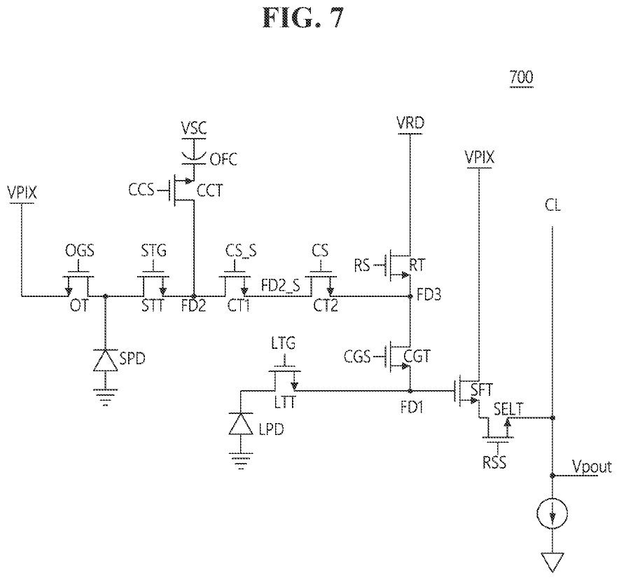

FIG. 7 shows an illustrative pixel circuit applicable to the image sensors of FIGS. 1A through 1C.

Referring to FIG. 7, a pixel 700, unlike the pixel 200 of FIG. 2, includes first and second connection transistors CT1 and CT2, which are connected between second and third floating nodes FD2 and FD3. An additional floating node FD2_S may be formed between the first and second connection transistors CT1 and CT2. The pixel 700 can accurately control the sensitivity of a second photodiode SPD using not only the sum of the capacitance of a storage capacitor OFC and the capacitances of a first floating node FD1, the second floating node FD2, and the third floating node FD3, but also the capacitance of the additional floating node FD2_S.

In the pixel 700, unlike in the pixel 200 of FIG. 2, a capacitor connection transistor CCT is connected to the second floating node FD2. During an exposure period, first portions of electric charge generated by the second photodiode SPD may be removed by an overflow transistor OT, second portions of the electric charge may be stored in the storage capacitor OFC via a second transfer transistor STT and the capacitor connection transistor CCT, and third portions of the electric charge may be stored in the second and third floating nodes FD2 and FD3 via the second transfer transistor STT and the first and second connection transistors CT1 and CT2.

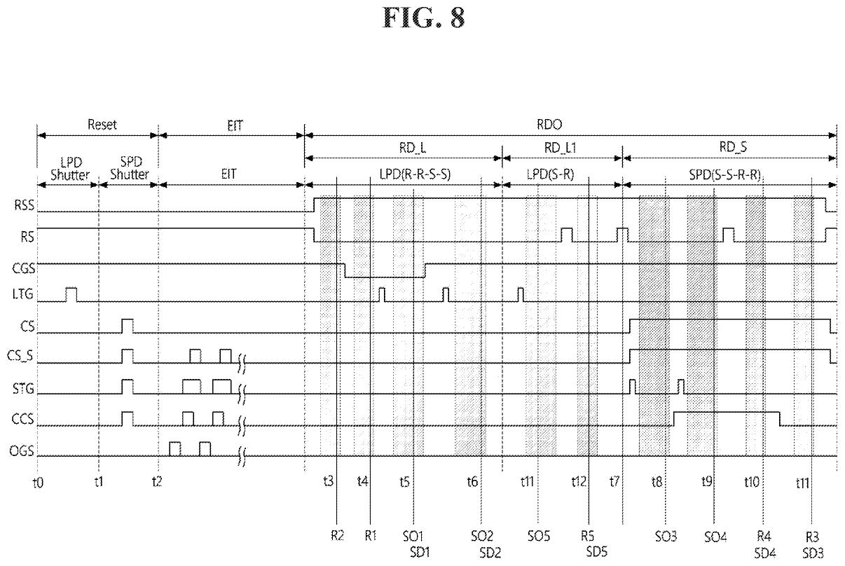

FIG. 8 shows timing for a second-mode operation of the pixel of FIG. 7.

Referring to FIG. 8, the period of the second-mode operation of the pixel 700 includes a reset period Reset, an exposure period EIT, and a read-out period RDO.

The reset period Reset includes a first-photodiode-shutter period “LPD Shutter” (from t0 to t1), during which a first transfer control signal LTG is toggled while maintaining a reset control signal and a conversion gain control signal CGS at the high level, and a second-photodiode-shutter period “SPD Shutter” (from t1 to t2), during which a connection control signal CS, an additional connection control signal CS_S, a second transfer control signal STG, and a capacitor connection control signal CCS are toggled. During the first-photodiode-shutter period “LPD Shutter,” the first photodiode LPD is reset. During the second-photodiode-shutter period “SPD Shutter,” the first, second, and third floating nodes FD1, FD2, and FD3, the additional floating node FD2_S, and the second photodiode SPD are reset.

During the exposure period EIT, an overflow gate control signal OGS, the second transfer control signal STG, the capacitor connection control signal CCS, and the additional connection control signal CS_S may be toggled multiple times while maintaining the reset control signal SR and the conversion gain control signal CGS at the high level and maintaining a first transfer control signal LTG at the low level. The first photodiode LPD may generate and accumulate electric charge by receiving light during the exposure period EIT. The second photodiode SPD may also generate and accumulate electric charge by receiving light during the exposure period EIT, but first portions of the electric charge is removed by the overflow transistor OT when the overflow gate control signal OGS is at the high level, second portions of the electric charge is stored in the storage capacitor OFC via the second transfer transistor STT and the capacitor connection transistor CCT when the second transfer control signal STG and the capacitor connection control signal CCS are toggled together, and third portions of the electric charge is transmitted to the additional floating node FD2_S via the second transfer transistor STT and the first connection transistor CT1 when the second transfer control signal STG and the additional connection control signal CS_S are toggled together. The length of the period when the second transfer control signal STG is toggled to the high level may be greater than the length of the period when the capacitor connection control signal CCS is toggled to the high level. The length of the period when the second transfer control signal STG is toggled to the high level may be greater than the length of the period when the additional connection control signal CS_S is toggled to the high level.

The amount of electric charge to be removed by the overflow transistor OT, such as the size of the first portions of the electric charge generated by the second photodiode SPD, may be controlled by controlling the number of times the overflow gate control signal OGS is toggled during the exposure period EIT or the duration that the overflow gate control signal OGS is maintained at the high level whenever toggled. The amount of electric charge to be stored in the storage capacitor OFC, such as the size of the second portions of the electric charge generated by the second photodiode SPD, may be controlled by controlling the number of times the capacitor connection control signal CCS is toggled during the exposure period EIT, the duration that the capacitor connection control signal CCS is maintained at the high level whenever toggled, and the length of overlapping periods between the periods when the capacitor connection control signal CCS is toggled and the periods when the second transfer control signal STG is toggled. The amount of electric charge to be stored in the additional floating node FD2_S, such as the size of the third portions of the electric charge generated by the second photodiode SPD, may be controlled by controlling the number of times the additional connection control signal CS_S is toggled during the exposure period EIT, the duration that the additional connection control signal CS_S is maintained at the high level whenever toggled, and the length of overlapping periods between when the additional connection control signal CS_S is toggled and when the second transfer control signal STG is toggled. Moreover, the amount of electric charge to be stored in the additional floating node FD2_S may be controlled by controlling the length of non-overlapping periods between the periods when the second transfer control signal STG is maintained at the high level and the periods when the capacitor connection control signal CCS or the additional connection control signal CS_S is maintained at the high level.

The read-out period RDO, like its counterpart of FIG. 6, includes a first-photodiode-read period RD_L, an additional read period RD_L1, and a second-photodiode-read period RD_S. The waveforms of the control signals applied during the first-photodiode-read period RD_L and the additional read period RD_L1 may be substantially the same as in the embodiment of FIG. 6, except that the additional connection control signal CS_S is maintained at the low level. Duplicate description may be omitted. At a time t7, the electric charge generated by the first photodiode LPD and then transmitted to the first and third floating nodes FD1 and FD3 are removed. Thereafter, the electric charge transmitted from the second photodiode SPD to the second floating node FD and the additional floating node FD2_S during the exposure period EIT and the electric charge generated after the exposure period EIT by the second photodiode SPD are shared with the first and third floating nodes FD1 and FD3 by switching the connection control signal CS and the additional connection control signal CS_S to the high level and toggling the second transfer control signal STG. Thereafter, at a time t8, a third sub-output signal SO3 is output with third conversion gain. Thereafter, the electric charge stored in the storage capacitor OFC and the electric charge generated by the second photodiode SPD are shared with the first and third floating nodes FD1 and FD3 by switching the capacitor connection control signal CCS to the high level and toggling the second transfer control signal STG. At a time t9, a fourth sub-output signal SO4 is output with fourth conversion gain. Thereafter, the storage capacitor OFC, the first, second, and third floating nodes FD1, FD2, and FD3, and the additional floating node FD2_S are all reset by toggling the reset control signal Rs. At a time t10, a fourth reset signal R4 corresponding to the fourth sub-output signal SO4 is output. Thereafter, the storage capacitor OFC is separated from the second floating node FD2 by switching the capacitor connection control signal CCS to the low level. At a time t11, a third reset signal R3 corresponding to the third sub-output signal SO3 is output.

Thereafter, the ADC block 130 of FIG. 1A generates first, second, third, fourth, and fifth sub-digital signals SD1, SD2, SD3, SD4, and SD5, as described above with reference to FIG. 6, and a detailed description of how to generate the first, second, third, fourth, and fifth sub-digital signals SD1, SD2, SD3, SD4, and SD5 may be omitted.

The additional read period RD_L1 need not be provided if the mode setting register 160 of FIG. 1A is set to the first operating mode.

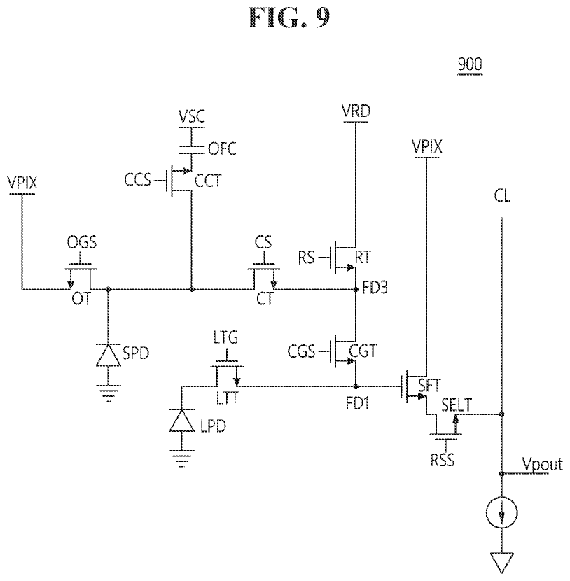

FIG. 9 illustrates a pixel circuit applicable to the image sensors of FIGS. 1A through 1C.

Referring to FIG. 9, a pixel 900 has substantially the same structure as the pixel 200 of FIG. 2 except that it does not include a second transfer transistor STT. Duplicate description may be omitted.

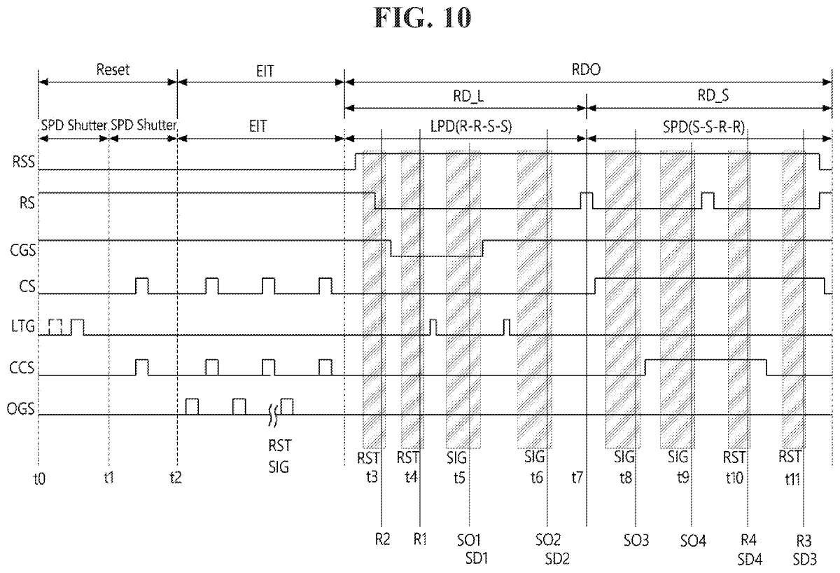

FIG. 10 shows timing for a first-mode operation of the pixel of FIG. 9.

Referring to FIG. 10, the period of the first-mode operation includes a reset period Reset, an exposure period EIT, and a read-out period RDO.

The reset period Reset includes a first-photodiode-shutter period “LPD Shutter” (from t0 to t1), during which a first transfer control signal LTG is toggled while maintaining a reset control signal RS and a conversion gain control signal CGS at the high level, and a second-photodiode-shutter period “SPD Shutter” (from t1 to t2), during which a connection control signal CS, a control signal for a connection transistor CT, and a capacitor connection control signal CCS, a control signal for a capacitor connection transistor CCT, are toggled. During the second-photodiode-shutter period “SPD Shutter,” a first floating node FD1, a third floating node FD3, a storage capacitor OFC, and a second photodiode SPD are reset.

During the exposure period EIT, an overflow gate control signal OGS, the capacitor connection control signal CCS, and the connection control signal CS may be toggled multiple times, while maintaining the reset control signal RS and the conversion gain control signal CGS at the high level and the first transfer control signal LTG at the low level. First portions of electric charge generated by the second photodiode SPD are removed by an overflow transistor OT when the overflow gate control signal OGS is toggled to the high level, second portions of the electric charge is stored in the storage capacitor OFC via the capacitor connection transistor CCT when the capacitor connection control signal CCS is toggled, and third portions of the electric charge is transmitted to the third floating node FD3 via the connection transistor CT and are then removed by a reset transistor RT, when the connection control signal CS is toggled. Periods when the connection control signal CS is toggled need not overlap with periods when the capacitor connection control signal CCS is toggled.

The amount of electric charge to be removed by the overflow transistor OT, such as the size of the first portions of the electric charge generated by the second photodiode SPD, may be controlled by controlling the number of times the overflow gate control signal OGS is toggled during the exposure period EIT or the duration that the overflow gate control signal OGS is maintained at the high level whenever toggled. The amount of electric charge to be stored in the storage capacitor OFC, such as the size of the second portions of the electric charge generated by the second photodiode SPD, may be controlled by controlling the number of times the capacitor connection control signal CCS is toggled during the exposure period EIT, the duration that the capacitor connection control signal CCS is maintained at the high level whenever toggled, and the length of overlapping periods between the periods when the capacitor connection control signal CCS is toggled and the periods when the second transfer control signal STG is toggled. The amount of electric charge to be removed via the third floating node FD3, such as the size of the third portions of the electric charge generated by the second photodiode SPD, may be controlled by controlling the number of times the connection control signal CS is toggled during the exposure period EIT and the duration that the additional connection control signal CS_S is maintained at the high level whenever toggled.

The read-out period RDO, like its counterpart of FIG. 5, includes a first-photodiode-read period RD_L and a second-photodiode-read period RD_S, and the waveforms of the control signals applied during the first-photodiode-read period RD_L are substantially the same as in the embodiment of FIG. 5. Duplicate description may be omitted. During the second-photodiode-read period RD_S, the connection control signal CS is maintained at the high level. A third sub-output signal SO3 is output at a time t8 by converting the electric charge accumulated in the second photodiode SPD, with third conversion gain, and a fourth sub-output signal SO4 is output at a time t9 by converting the electric charge stored in the storage capacitor OFC and the electric charge generated by the second photodiode SPD, with fourth conversion gain. Thereafter, a fourth reset signal corresponding to the fourth sub-output signal SO4 and a third reset signal R3 corresponding to the third sub-output signal SO3 are output.

Thereafter, the ADC block 130 of FIG. 1A generate first, second, third, and fourth sub-digital signals SD1, SD2, SD3, and SD4, as described above with reference to FIG. 5, and a detailed description of how to generate the first, second, third, and fourth sub-digital signals SD1, SD2, SD3, and SD4 may be omitted.

When the mode setting register 160 of FIG. 1A is set to the second operating mode, an additional read period such as the additional read period RD_L1 of FIG. 6 may be further provided between the first-photodiode-read period RD_L and the second-photodiode-read period RD_S.

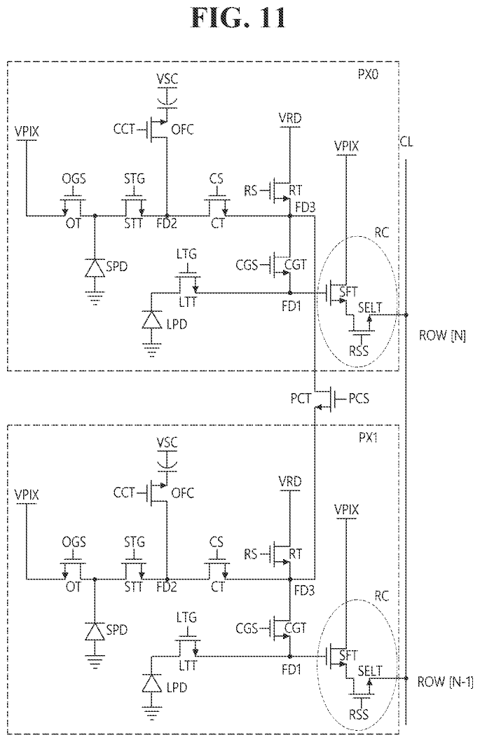

FIG. 11 illustrates a circuit showing how pixels are connected.

Referring to FIG. 11, first and second pixels PX0 and PX1, which are adjacent to each other in a column direction, may be connected to substantially the same column line CL and may be connected to each other by a pixel connection transistor PCT. The first pixel PX0 may be disposed in a first row “ROW [N]”, and the second pixel PX1 may be disposed in a second row “ROW [N-1]”. The second row N-1 may be one of rows to be read ahead of the first row N.

Each of the first and second pixels PX0 and PX1 has substantially the same structure as the pixel 200 of FIG. 2, except that a capacitor connection transistor CCT is connected to a second floating node FD2. Duplicate description may be omitted. In each of the first and second pixels PX0 and PX1, the capacitor connection transistor CCT may be connected to the anode of a second photodiode SPD, as illustrated in FIG. 2.

The pixel connection transistor PCT may be disposed between a third floating node FD3 of the first pixel PX0 and a third floating node FD3 of the second pixel PX1 and may be controlled by a pixel connection control signal PCS. That is, when the pixel connection transistor PCT is turned on, the capacitances of the third floating nodes FD3 of the first and second pixels PX0 and PX1 may be summed up, and thus, conversion gain can be controlled with a larger capacitance.

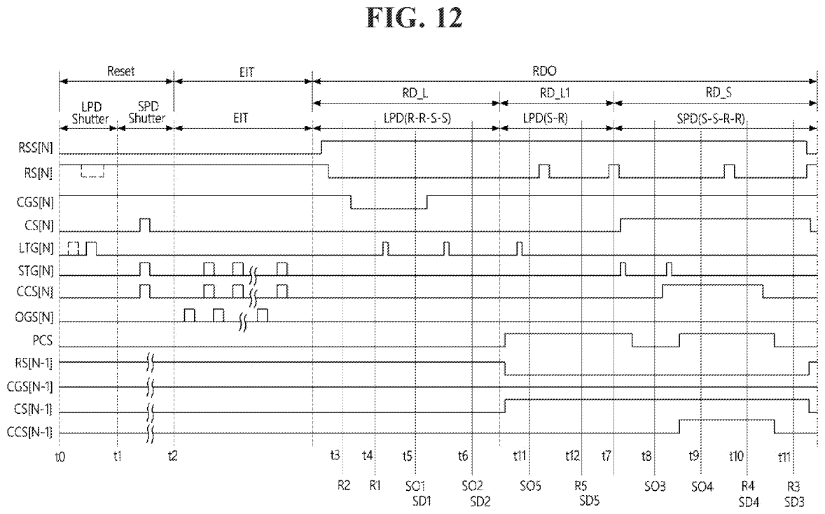

FIG. 12 shows timing for second-mode operations of the pixels of FIG. 11.

Referring to FIG. 12, a reset period Reset, an exposure period EIT, a first-photodiode-read period RD_L, an additional read period RD_L1, and a second-photodiode-read period RD_S are provided. Here, the additional read period RD_L1 is a period when electric charge is output from a first photodiode LPD of the first pixel PX0 again. The reset period Reset and the exposure period EIT may be substantially the same as their respective counterparts of FIG. 5. Duplicate description may be omitted. The amounts of electric charge to be removed by an overflow transistor OT of the first pixel PX0, to be stored in a storage capacitor OFC of the first pixel PX0, and to be stored in a second floating node FD2 of the first pixel PX0 via a second transfer transistor STT of the first pixel PX0, during the exposure period EIT, among electric charge generated by a second photodiode SPD of the first pixel PX0, may be controlled by the number of times and the duration that an overflow gate control signal OGS[N], a capacitor connection control signal CCS[N], and a second transfer control signal STG[N] are toggled to, and maintained at, the high level.

During the additional read period RD_L (from t3 to t6), the control signals applied to the first pixel PX0 may be controlled in substantially the same manner as in the embodiment of FIG. 5. Duplicate description may be omitted. In this manner, a second reset signal R2 with second conversion gain, a first reset signal R1 with first conversion gain, a first sub-output signal SO1 with the first conversion gain, and a second sub-output signal SO2 with the second conversion gain may be generated from the electric charge generated by the first photodiode LPD of the first pixel PX0. During the additional read period RD_L, the pixel connection control signal PCS is turned off to the low level.

After a time t6, the pixel connection control signal PCS is switched to the high level so that the pixel connection transistor PCT is turned on. As a conversion gain control signal CGS[N-1] and a connection control signal CS[N-1] for the second pixel PX1 are both at the high level when the pixel connection transistor PCT is turned on, the first, second, and third floating nodes FD1, FD2, and FD3 of the second pixel PX1 are connected to the third floating node FD3 of the first pixel PX0. Thereafter, a fifth sub-output signal SO5 and a fifth reset signal R5 corresponding to the fifth sub-output signal SO5 are output at times t11 and t12, respectively, by converting the electric charge generated by the first photodiode LPD of the first pixel PX0, with larger capacitance. That is, the fifth sub-output signal SO5 and the fifth reset signal R5 may be generated with conversion gain less than the second conversion gain, and thus, the first photodiode LPD of the first pixel PX0 can sense a brighter image.

At a time t7, the electric charge in the first and third floating nodes FD1 and FD3 of the first pixel PX0 and the electric charge in the first, second, and third floating nodes FD1, FD2, and FD3 of the second pixel PX1 are all reset. A third sub-output signal SO3 is output at a time t8 by converting the electric charge in each of the second photodiode SPD and the second floating node FD2 of the first pixel PX0 with the third conversion gain with a connection control signal CS[N] and the capacitor connection control signal CCS[N] at the high and low levels, respectively. Thereafter, the connection control signal CS[N] and the pixel connection signal PCS are switched to the high level so that the electric charge in the first, second, and third floating nodes FD1, FD2, and FD3 and the storage capacitor OFC of the first pixel PX0 are shared with the first, second, and third floating nodes FD1, FD2, and FD3 of the second pixel PX1, and a fourth sub-output signal SO4 is output at a time t9 by converting the shared electric charge with the fourth conversion gain. Thereafter, a fourth reset signal R4 corresponding to the fourth sub-output signal SO4 and a third reset signal R3 corresponding to the third sub-output signal SO3 are output at a time t10 and the time t11, respectively.

Thereafter, the ADC block 130 of FIG. 1A may generate first, second, third, fourth, and fifth sub-digital signals SD1, SD2, SD3, SD4, and SD5, as described above with reference to FIG. 6, and a detailed description of how to generate the first, second, third, fourth, and fifth sub-digital signals SD1, SD2, SD3, SD4, and SD5 may be omitted.

When the mode setting register 160 of FIG. 1A is set to the first operating mode, the additional read period such as the additional read period RD_L1 of FIG. 12 need not be provided.

According to embodiments of the present disclosure, the saturation of electric charge generated in photodiodes with relatively small light-receiving areas can be prevented at high illumination by controlling the amounts of electric charge to be removed via overflow transistors and to be stored in storage capacitors, and as a result, high dynamic ranges can be secured.

Moreover, decreases in signal-to-noise ratios (SNR) that may be caused by conversion gain variations can be minimized by converting into image signals electric charge generated by photodiodes with relatively small light-receiving areas and then transmitted to floating nodes in pixels, rather than resetting the electric charges.

In concluding the detailed description, those of ordinary skill in the pertinent art shall appreciate that many variations and modifications may be made to the described embodiments without substantially departing from the principles of the present invention. Therefore, the disclosed embodiments of the invention are used in a generic and descriptive sense only, and not for purposes of limitation.

What is claimed is:

1. An image sensor comprising:
a plurality of pixels, wherein each of the plurality of pixels comprises:
a first photodiode;
a second photodiode;
an overflow transistor having a first end connected to the second photodiode and a second end connected to a first voltage node;
a storage capacitor having a first end and a second end connected to a second voltage node;
a capacitor connection transistor having a first end connected to the first end of the storage capacitor and a second end connected to the second photodiode;
a first transistor connected to the first photodiode;
a second transistor connected to the second photodiode;
a first floating node connected to the first photodiode through the first transistor;
a second floating node connected to the second photodiode through the second transistor;
a conversion gain transistor between the first floating node and the second floating node;
a driving transistor connected to the first photodiode; and
a selection transistor connected to the driving transistor,
wherein the first photodiode has a larger light receiving area in a plan view than the second photodiode.

2. The image sensor of claim 1, wherein each of the plurality of pixels further comprises a reset transistor connected to the second floating node.

3. The image sensor of claim 2, wherein the first photodiode is disposed on a first region and the second photodiode is disposed on a second region, and
wherein the first region is separated from the second region by a trench isolation.

4. The image sensor of claim 3, wherein the second transistor is disposed on the first region in the plan view.

5. The image sensor of claim 4, wherein the conversion gain transistor and the reset transistor are disposed on the first region in the plan view.

6. The image sensor of claim 1, wherein each of the plurality of pixels further comprises a third transistor between the second transistor and the second photodiode.

7. The image sensor of claim 6, wherein each of the plurality of pixels further comprises a fourth transistor between the third transistor and the second photodiode.

8. The image sensor of claim 7, wherein the capacitor connection transistor is connected to the second photodiode through the fourth transistor.

9. The image sensor of claim 1, wherein the driving transistor is connected to the first voltage node.

10. The image sensor of claim 2, wherein the driving transistor and the selection transistor are arranged in a first direction in the plan view, and
wherein the conversion gain transistor and the reset transistor are arranged in the first direction in the plan view.

11. The image sensor of claim 1, wherein the storage capacitor is a metal insulator metal capacitor.

12. The image sensor of claim 2, wherein the first transistor, the conversion gain transistor, and the reset transistor are sequentially arranged in a first direction in the plan view.

13. The image sensor of claim 12, wherein the driving transistor and the selection transistor are arranged in the first direction in the plan view.

14. The image sensor of claim 3, wherein the first region has an octagon shape in the plan view.

15. The image sensor of claim 3, wherein the capacitor connection transistor is disposed on the second region in the plan view.

16. An image sensor comprising:
a pixel connection transistor; and
a plurality of pixels comprising a first pixel and a second pixel, wherein each of the first and second pixels comprises:
a first photodiode;
a second photodiode;
an overflow transistor having a first end connected to the second photodiode and a second end connected to a first voltage node;
a storage capacitor having a first end and a second end connected to a second voltage node;
a capacitor connection transistor having a first end connected to the first end of the storage capacitor and a second end connected to the second photodiode;
a first transistor connected to the first photodiode;
a second transistor connected to the second photodiode;
a first floating node connected to the first photodiode through the first transistor;
a second floating node connected to the second photodiode through the second transistor;
a conversion gain transistor between the first floating node and the second floating node;
a driving transistor connected to the first photodiode; and
a selection transistor connected to the driving transistor,
wherein the first pixel is connected to the second pixel through the pixel connection transistor.

17. The image sensor of claim 16, wherein the pixel connection transistor is connected to the second floating node of the first pixel and the second floating node of the second pixel.

18. The image sensor of claim 16, wherein the storage capacitor is a metal insulator metal capacitor.

19. The image sensor of claim 16, wherein the first photodiode is disposed on a first region and the second photodiode is disposed on a second region, and
wherein the first region is separated from the second region by a trench isolation.

20. The image sensor of claim 16, wherein each of the plurality of pixels further comprises a third transistor between the second transistor and the second photodiode.
